(19) United States
(12) Patent Application Publication
(10) Pub. No.: US 2008/0163103 A1
(43) Pub. Date: Jul. 3, 2008

(54) APPARATUS AND METHOD FOR IDENTIFYING EDGES OF DOCUMENTS

(75) Inventors: Erika Reponen, Tampere (FI); Virpi Roto, Espoo (FI)

Correspondence Address: PERMAN & GREEN, 425 POST ROAD, FAIRFIELD, CT, 06824, US

(73) Assignee: Nokia Corporation, Espoo (FI)

(21) Appl. No.: 11/618,087

(22) Filed: Dec. 29, 2006

(51) Int. Cl. G06F 3/048

(52) U.S. Cl. 715/788; 715/851

(57) ABSTRACT

An apparatus including a display having a viewable area and a processor connected to the display, the processor being configured to present a border along edges of a document so that the border indicates a proximity of a corresponding edge of the document to the viewing area.

### BACKGROUND

1. Field

The disclosed embodiments relate to user interfaces and, more particularly, to user interfaces for navigating a document.

2. Brief Description of Related Developments

With conventional document viewers such as web browsers, word processing applications and the like, scroll bars, zoom indicators and arrows are employed to position or indicate a user's location on the document when only a portion of the document can be presented to the user. These scroll bars, zoom indicators and arrows can take up a significant amount of space on a display depending on the size of the display. The scroll bars, zoom indicators and arrows can also cover up or obstruct the content of the document being displayed.

It would be advantageous to be able to indicate to a user where an edge or border of a document or web page is without the need to occupy an area on the display of the device.

### SUMMARY

In one embodiment, an apparatus is provided. The apparatus includes a display having a viewable area and a processor connected to the display, the processor being configured to present a border along edges of a document so that the border indicates a proximity of a corresponding edge of the document to the viewing area.

In another embodiment, a method is provided. The method includes providing a viewable area, providing a document within the viewing area where a portion of the document is presented in the viewing area and providing a border along the edges of the document to indicate a proximity of the edges of the document to the viewable area.

In one embodiment, a computer program product is provided. The computer program product includes a computer useable medium having computer readable code means embodied therein for causing a computer to indicate a proximity of edges of a document to a viewable area. The computer readable code means in the computer program product includes computer readable program code means for causing a computer to present a border along the edges of a document so that the border indicates a proximity of a corresponding edge of the document to the viewing area.

### BRIEF DESCRIPTION OF THE DRAWINGS

The foregoing aspects and other features of the disclosed embodiments are explained in the following description, taken in connection with the accompanying drawings, wherein:

FIG. 1 is a schematic illustration of a document incorporating features of an embodiment;

FIG. 2 illustrates a flow chart in accordance with an embodiment;

FIGS. 3A-3C are screen shots of examples of a document incorporating features an embodiment;

FIG. 4 illustrates a flow chart in accordance with an embodiment;

FIG. 5 shows a device incorporating features of an embodiment;

FIG. 6 shows another device incorporating features of an embodiment;

FIG. 7 is a block diagram illustrating the general architecture of an exemplary mobile devices in which aspects of the embodiments may be applied;

FIG. 8 is a schematic illustration of a cellular telecommunications system, as an example, of an environment in which a communications device incorporating features of an exemplary embodiment may be applied; and

FIG. 9 illustrates a block diagram of an example of an apparatus incorporating features that may be used to practice aspects of the disclosed embodiments.

### DETAILED DESCRIPTION OF THE EXEMPLARY EMBODIMENT(S)

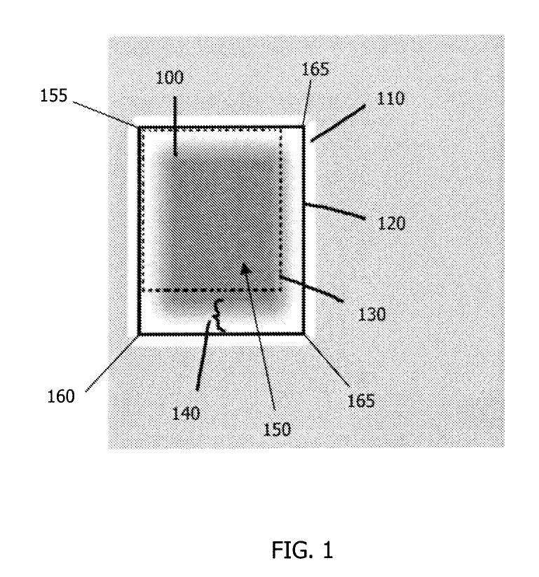

FIG. 1 is an illustration of a document 150 incorporating features of an embodiment. Although the embodiments disclosed will be described with reference to the embodiments shown in the drawings, it should be understood that the embodiments disclosed can be embodied in many alternate forms of embodiments. In addition, any suitable size, shape or type of elements or materials could be used.

As can be seen in FIG. 1, the document 150 includes a border 120 having an upper left corner 155, a lower left corner 160, a lower right corner 165 and an upper right corner 165. The term document is generally meant to include, but is not limited to, any suitable medium for the display of data and information, such as such as for example, a web page, a spreadsheet, a word processing document, a photograph, video, and the like. The document 150 may be displayed on a screen that is insufficient to show the entire document or a user may have the screen setting adjusted so the document is displayed larger than its actual size for easy viewing by the user. For example, in mobile phone devices, web pages and other documents need to be scaled to fit, since the viewable area is reduced. In other embodiments the document may be displayed in an application area such as, for example, a window that is sized smaller than the document. The dashed line 130 indicates the screen or application area border (hereinafter the “viewing area”) and reference number 100 indicates the visible part of the document.

Where document 150 is larger than the viewing area 130 some areas of the document 150 are not presented to the user such as for example, in FIG. 1 the right and bottom sides of the document would not be presented to a user as they are located outside the viewing area 130. Because the user cannot see the edges of the document it may be difficult for the user to know where the user is within the document without the aid of navigation tools such as scroll bars, zoom indicators, arrow and the like. However these navigation tools take up space in the viewing area and may obstruct or block content of the document from being viewed by the user.

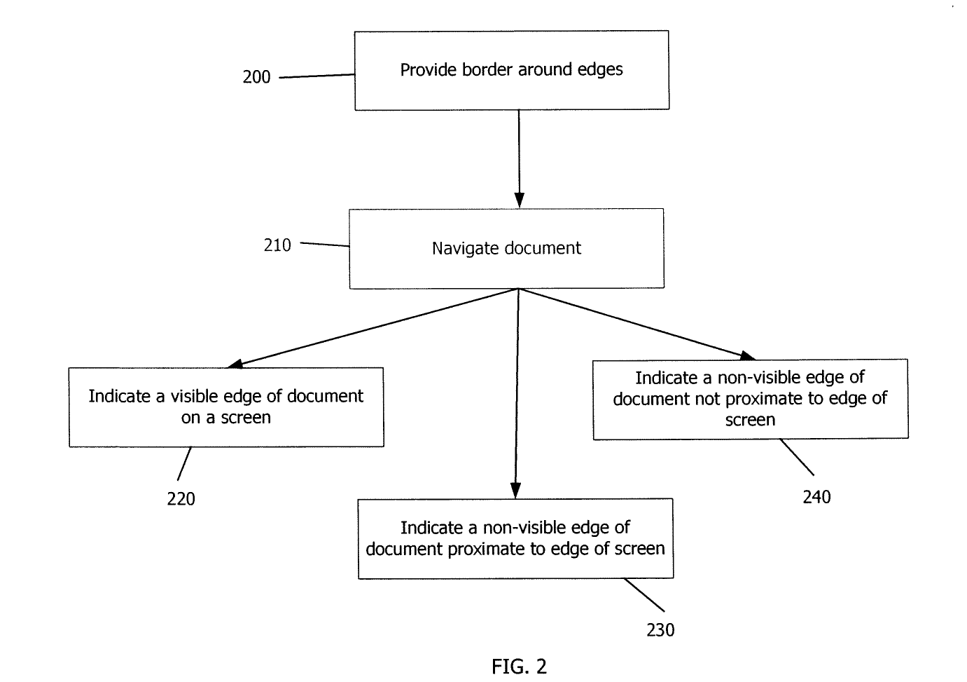

Still referring to FIG. 1 and also to FIG. 2, in accordance with the embodiments described herein a border 110 may be placed around the edges or sides of the document or in the corners of the document to indicate to a user where the edges of the document are in relation to the viewable area of the display (FIG. 2, Block 200). Characteristics of the border may be most intense around the edges of the document and decrease as the border extends into the document. For example, the border 110 in FIG. 1 extends into the document 150 an amount indicated by reference number 140. The changing characteristics of the border 110 may indicate to the user a location of an edge of the document. For example, when a user scrolls or navigates the document (FIG. 2, Block 210), the characteristics of the border changes depending on where the edges of the documents are in relation to the edges of the screen 130. The more intense border visible along the top and left side of the screen 130 indicates to a user that the top and left edges of the document are along the corresponding visible edges of the screen 130 (FIG. 2, Block 220). The faint characteristics of the border 110 along the right edge of the screen 130 indicates to the user that the right edge of the document 150 is “near” or proximate to the right edge of the screen 130 (FIG. 2, Block 230). The lack of any border characteristics along the bottom of the screen may indicate to the user that the bottom edge of the document 150 is away from or not proximate to the bottom edge of the screen 130 (FIG. 2, Block 240).

In accordance with an embodiment the border may include any suitable indicator or visualization along the edges and/or in the corners of the document to aid navigation in the document without having navigation tools displayed on the screen. For example, the border may include any two-dimensional or three-dimensional visualizations, graduated colors, animations and the like as will be described in greater detail below. The user may be able to personalize the border with for example, images stored in the device or otherwise acquired by the device that are, for example, resized and “sprinkled” along the edges of the document. In alternate embodiments the user may be able to customize any suitable aspects of the disclosed embodiments. In alternate embodiments, the navigation tools may be presented on the screen and employed along with the disclosed embodiments.

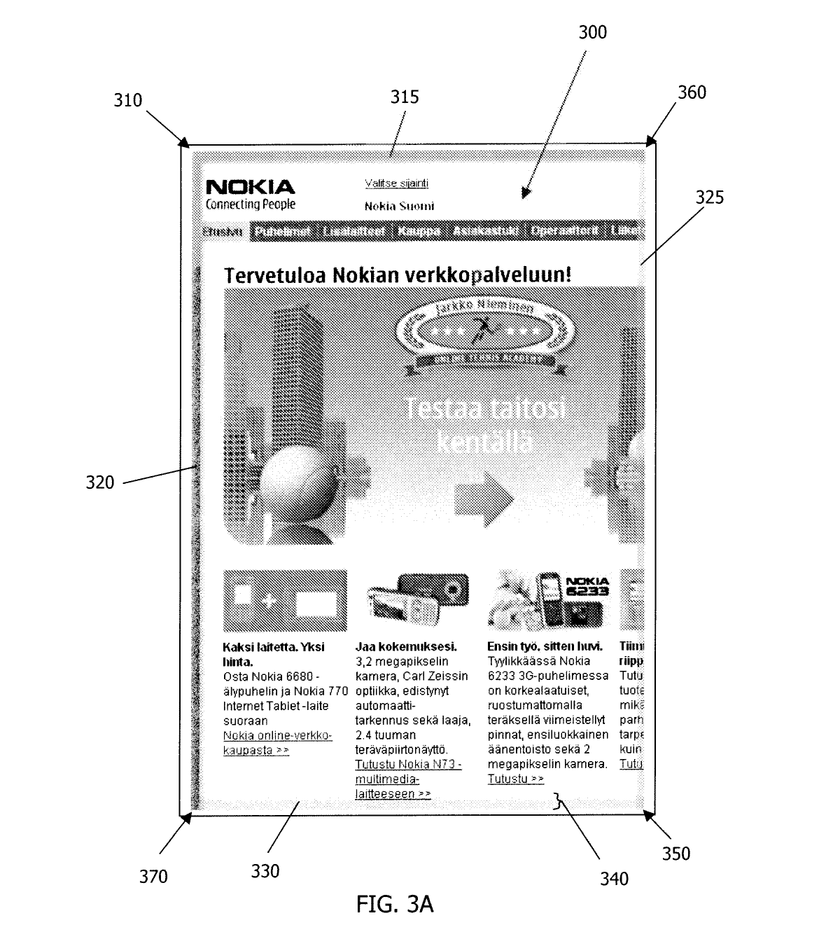

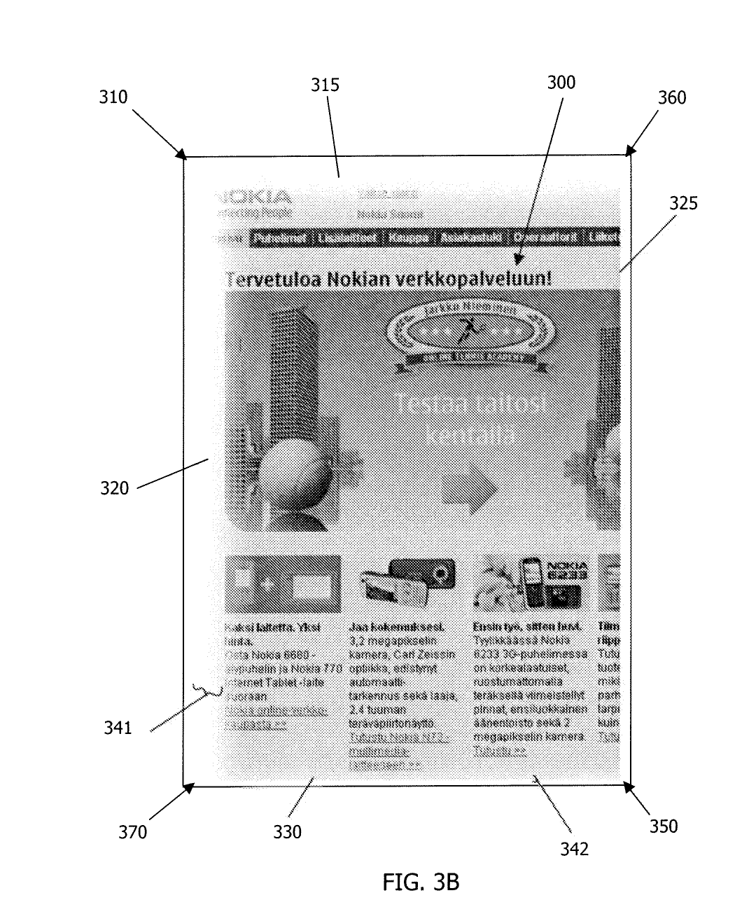

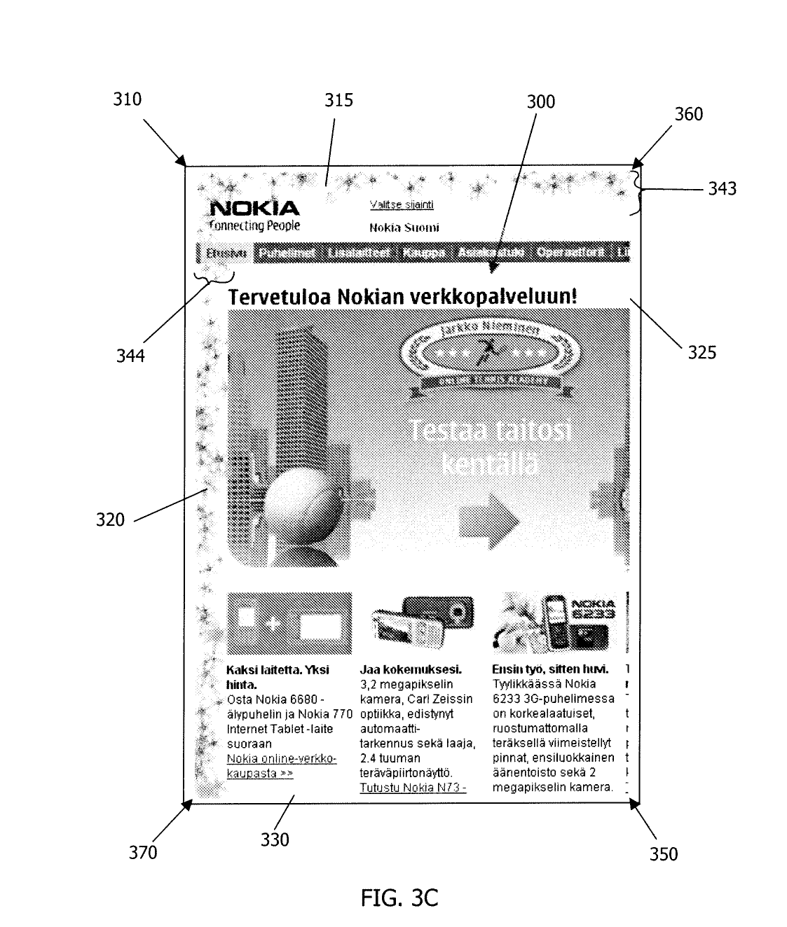

Referring now to FIG. 3A, a screen shot of a user interface is shown, illustrating an example of the disclosed embodiments. Although the embodiments described herein are described with respect to a single viewing area 130, it is noted that several viewing areas may be presented on the display of the device at one time. The embodiments described herein may be applied individually to each of the viewing areas so that the same or different visualizations appear in each of the viewing areas.

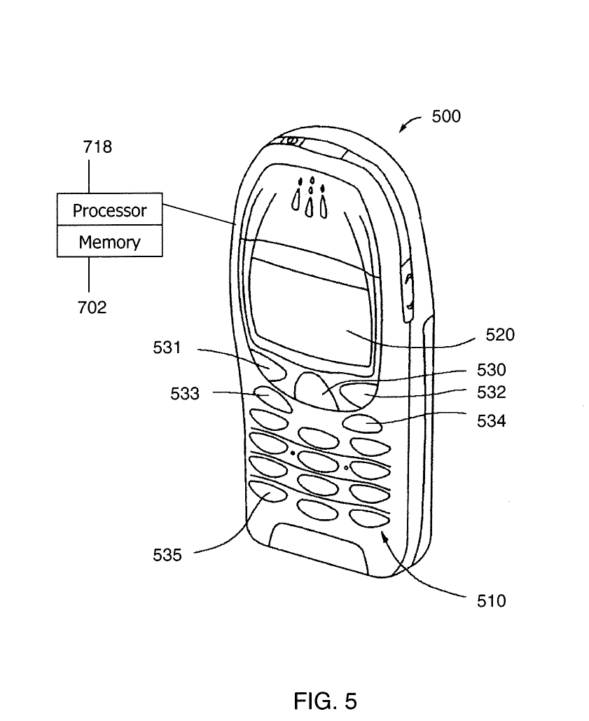

The screen shot in FIG. 3A may represent what is shown in the viewing area 130 of any suitable device as described above with respect to FIG. 1. The embodiments disclosed herein will be described with reference to the mobile communications device 500 of FIG. 5 for exemplary purposes only and it should be understood that the embodiments could be applied equally to any suitable device including, for example, a display, processor, memory and supporting software or hardware for implementing aspects of the disclosed embodiments.

In FIG. 3A reference numerals 315, 330, 320 and 325 respectively indicate the top, bottom, left and right sides of the viewing area 130. In FIG. 3A a web page 300 is shown, however in other embodiments any suitable document may be shown such as, for example, spreadsheets, word processing documents, emails, multimedia messages, videos, photos and the like. Any suitable border is placed around the edges of the web page 300. In this example the border is a color gradation. In other embodiments the border may be any suitable border, such as two-dimensional or three-dimensional visualizations (e.g. smoke, stardust, flames, lightning, hearts, snowflakes, color gradations, lights, animations, etc.) that vary with intensity (e.g. fade) as they extend away from the edges of the document. The visualizations can be used separately or in combination with each other. The depth 340 of the border (i.e. the distance that the border extends into the document) may be such that the border ends before it reaches the content of the document. In other embodiments the border may be sufficiently transparent so as not to interfere with viewing the document. The device, 500 may have any suitable setting menu for setting the depth of the border, the transparency of the border, the type of visualization included in the border or any other suitable attribute of the border. In alternate embodiments the border may be added to, for example, the web page or other document by the creator of the document or any suitable service provider such as, for example, an internet service provider.

As can be seen in FIG. 3A the color gradation is most intense along the left edge 320 and top edge 315. The color gradations along the left edge 320 and top edge 315 are also of the same intensity which indicates to the user of the device 500 that corner 310 is the upper left corner of the web page 300. If, for example the user scrolls the document in a downward direction via any suitable key of the device 500 such as, for example, a scroll key, the intensity of the color gradation along the top edge 315 would decrease or fade indicating to the user that the user is moving away from the top edge of the document. In alternate embodiments the user may scroll the document using a pointer on a touch enabled screen of the device 500. In other alternate embodiments the user may scroll through the document in any suitable manner.

Looking now at corner 370, the intensity of the color gradation at the left edge 320 is greater than that of the bottom edge 330 which indicates that corner 370 is somewhere between the top left corner and bottom left corner of the document. The intensity of the color gradation, which is fairly light, along the edge 330 indicates that the bottom of the document is away from the edge 330 of the viewing area. The same is true for corner 360. The intensity of the color gradation at the right edge 325 is less than that of the top edge 315 which indicates that corner 360 is somewhere between the top left corner and top right corner of the document. The intensity of the color gradation, which is not as light as the intensity along edge 330 indicates that the right edge of the document is away from edge 325 but that the right edge of the document is closer to the viewing area than the bottom edge of the document. Looking now at corner 350, the intensities of the gradation along edges 325 and 330 are not similar which indicates to the user that the corner 350 is somewhere on an interior portion of the document. As the user scrolls around the document, the color gradations or lack thereof along the edges of the viewing area change according to the direction of the scrolling so the user intuitively knows where the user is within the document. Although the disclosed embodiments are described having the border along the edges of the document, in alternate embodiments the border may be present only in the corners of the documents or at any other suitable place in the document. For example, in one embodiment, the visual effects may be coming or appear only from the corners of the area.

Referring to FIG. 3B, another screen shot of a user interface is shown, illustrating an example of the disclosed embodiments. The screen shot may represent what is shown in the viewing area 130 of a device as described above with respect to FIG. 1. Reference numeral 315, 330, 320 and 325 respectively indicate the top, bottom, left and right sides of the viewing area 130. In FIG. 3B the web page 300 is shown, however in other embodiments any suitable document may be shown as described above. As can be seen in FIG. 3B the border may be a virtual light that is placed along the top, bottom, and sides of the document. The virtual light may have any suitable color. The color of the light may be specified by a user of the device, specified by a creator of the document or determined by the device depending on the background colors of the document. For example, the device may choose a color for the light that contrasts with the background of the document so that the edges of the document are readily discernable by the user.

The virtual light may project a lighted area (i.e. the depth of the border) such as, for example, area 340 along each of the edges of the document. In this example, the depth of the border along the edges of the document is sufficiently transparent so as not to interfere with viewing the document. In other embodiments the depth of the border may terminate before reaching a content of the document.

As can be seen in FIG. 3B the light is most intense along the left edge 320 and top edge 315 of the viewing area 130. The intensities of the light along the left edge 320 and top edge 315 are also the same which indicates to the user of the device 500 that corner 310 is the upper left corner of the web page 300. Looking at corner 370, the intensity of the light at the left edge 320 is greater than that of the bottom edge 330. The depth 341 of the light along the left edge 320 is also greater than the depth 342 of the light along the bottom edge 330. This variation in intensity and depth of the light along the left and bottom edges 320, 330 indicates that corner 370 is somewhere between the top left corner and bottom left corner of the document. The shallow depth and dim intensity of the light along the edge 330 indicates that the bottom of the document is away from the edge 330 of the viewing area. The same is true for corner 360. The intensity or lack thereof of the light at the right edge 325 is less than that of the top edge 315 which indicates that corner 360 is somewhere between the top left corner and top right corner of the document. The lack of light intensity along edge 325 indicates that the right edge of the document is away from edge 325 and that the right edge of the document is farther from the viewing area than the bottom edge of the document. Looking now at corner 350, the light intensities along edges 325 and 330 are not similar which indicates to the user that the corner 350 is somewhere on in an interior portion of the document. As the user scrolls or navigates the document, the light intensity along the edges of the viewing area changes according to the direction of the scrolling so the user intuitively knows where the user is within the document.

Referring to FIG. 3C, a screen shot of a user interface is shown, illustrating an example of the disclosed embodiments. The screen shot may represent what is shown in the viewing area 130 of a device as described above with respect to FIG. 1. Reference numeral 315, 330, 320 and 325 respectively indicate the top, bottom, left and right sides of the viewing area 130. In FIG. 3C the web page 300 is shown, however in other embodiments any suitable document may be shown as described above. As can be seen in FIG. 3C a stardust visualization is placed along the edges of the web page 300 but in alternate embodiments any suitable visualization can be placed along the edges of the document. The stardust visualization may be an animated visualization where the stars “twinkle” or move around. In other embodiments the individual particles of stardust may be replaced with user defined images, icons or the like. For example, a user may obtain an image of a bird (e.g. from a memory of the device, an external source, a camera of the device, etc.) and through a suitable settings menu the user may configure the visualization so that the image of the bird is resized, cropped or otherwise shrunk so that the image can be “sprinkled” along the edges of the document in a manner similar to that shown with respect to the stardust. In alternate embodiments more than one image may be “sprinkled” throughout the visualization. In other embodiments the image may be placed “behind” the document so that the edges of the image are shown in a manner described above with respect to the virtual light (e.g. the image is displayed so that the image fades towards the center of the document in the same fashion as the virtual light). In other embodiments the visualizations may be any suitable visualizations generated by a processor of the device.

In this example, the depth of the visualization along the edges of the document is sufficiently transparent so as not to interfere with viewing the document. In other embodiments the depth of the visualization may terminate before reaching a content of the document.

As can be seen in FIG. 3C the intensity of the stardust is greatest along the left edge 320 and top edge 315 of the viewing area 130. The intensities and depth 344, 343 of the star dust along the left edge 320 and top edge 315 respectively are also the same which indicates to the user of the device 500 that corner 310 is the upper left corner of the web page 300. Looking at corner 370, the intensity of the stardust at the left edge 320 is greater than that of the bottom edge 330. The depth 344 of the stardust along the left edge 320 is also greater than the depth of the stardust along the bottom edge 330 (in this example there is an absence of stardust along the bottom edge). This variation in intensity and depth of the stardust along the left and bottom edges 320, 330 indicates that corner 370 is somewhere between the top left corner and bottom left corner of the document. The absence of the stardust along the edge 330 indicates that the bottom of the document is away from the edge 330 of the viewing area. The same is true for corner 360. The intensity or lack thereof of the stardust at the right edge 325 is less than that of the top edge 315 which indicates that corner 360 is somewhere between the top left corner and top right corner of the document. The lack of stardust along right and bottom edges 325, 330 of the viewing area 130 indicate to the user that the bottom right corner 350 is somewhere on an interior portion of the document. As the user scrolls around the document, the intensities and depths of the stardust along the edges of the viewing area change according to the direction of the scrolling so the user intuitively knows where the user is within the document.

In the each of the embodiments shown in FIGS. 3A through 3C the same visualization is shown along each of the edges 315, 320, 330, 325. In alternate embodiments a different visualization may be shown along each of the edges, for example a red color gradation or light may be shown along edge 320, a blue color gradation or light may be shown along edge 330, a yellow color gradation or light may be shown along edge 325 and a purple color gradation or light may be shown along edge 315. In another example, stardust may be shown along edge 320, smoke may be shown along edge 330, lightning may be shown along edge 325 and snow may be shown along edge 315. In other alternate embodiments any combination of lights, colors, images, videos and the like may be employed along the various edges of the document to form the visualizations disclosed herein.

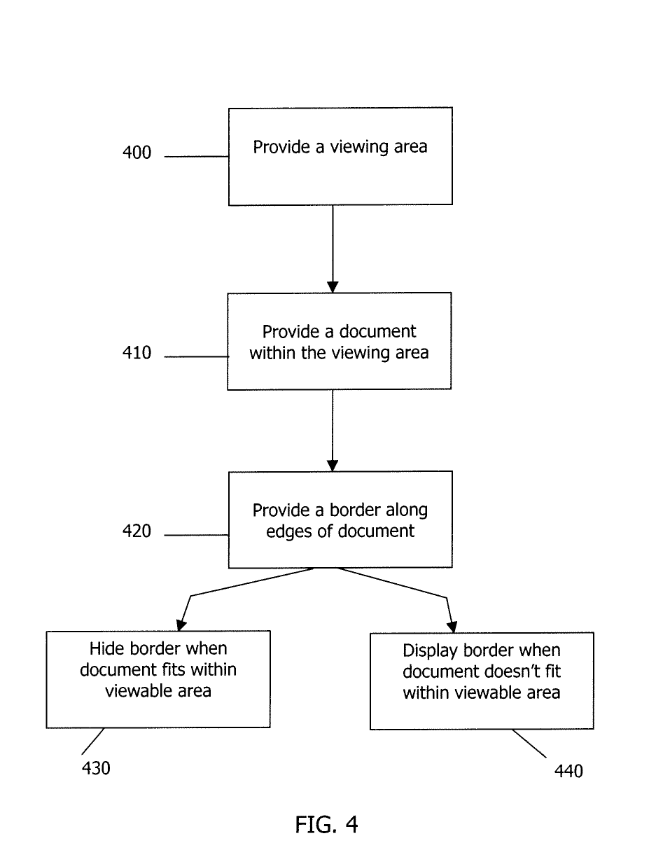

Referring now to FIGS. 1 and 4, an exemplary operation of the disclosed embodiment will be described. A viewing area 130 is provided on the display of the device 500 (FIG. 4, Block 400). A document is provided within that viewing area 130 where the document has a border 120 that is larger than the viewing area 130 (FIG. 4, Block 410). The document may be provided from any suitable source such as, for example, from a memory of the device 200, from the internet via a web browser, camera and the like. A border is provided around the edges of the document where an intensity of the visualization is greatest at the edges and decreases or fades as the visualization is extended towards the center of the document (FIG. 4, Block 420). The border may be any suitable border as described above and may be provided by the creator of the document (e.g. web page designer, the author of a word processing document, etc.), any suitable service provider (e.g. a cellular service provider, an internet service provider, etc.) or added by the user via any suitable settings menu within the device 500.

Where for example the viewing area 130 is capable of being expanded so that the document border 120 fits within the viewing area 130 of the device 500, the border around the edges of the document may disappear, be hidden or otherwise be turned off (FIG. 4, Block 830). When the viewing area 130 is reduced so that the border 120 of the document no longer fits within the viewing area 130, the border around the edges of the document may appear or otherwise be turned on (FIG. 4, Block 840). In other embodiments, the border may be presented on the document when the border 120 of the document fits within the viewing area 130.

The exemplary device or terminal 500 in which the disclosed embodiments may be employed is illustrated in more detail in FIG. 5. The terminal 500 may have a keypad 510 and a display 520. The keypad 510 may include any suitable user input devices such as, for example, a multi-function/scroll key 530, soft keys 531, 532, a call key 533 and end call key 534 and alphanumeric keys 535. The display 520 may be any suitable display, such as for example, a touch screen display or graphical user interface. The display may be integral to the device 500 or the display may be a peripheral display connected to the device 500. A pointing device, such as for example, a stylus, pen or simply the user's finger may be used with the display 520. In alternate embodiments any suitable pointing device may be used. In other alternate embodiments, the display may be a conventional display. The device 500 may also include other suitable features such as, for example, a camera, loud speaker, connectivity port or tactile feedback features. The mobile communications device may have a processor 718 connected to the display for processing user inputs and displaying information on the display 520. A memory 702 may be connected to the processor 718 for storing any suitable information and/or applications associated with the mobile communications device 500 such as phone book entries, calendar entries, web browser, etc.

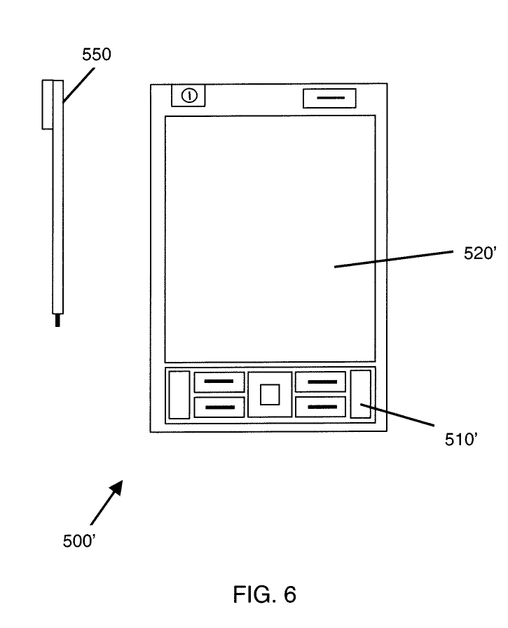

In one embodiment, the device, may be for example, a PDA style device 500′ illustrated in FIG. 6. The PDA 500′ may have a keypad 510′, a touch screen display 520′ and a pointing device 550 for use on the touch screen display 520′. In still other alternate embodiments, the device may be a personal communicator, a tablet computer, a laptop or desktop computer, a television or television set top box or any other suitable device capable of containing the display 520 and supported electronics such as the processor 718 and memory 702.

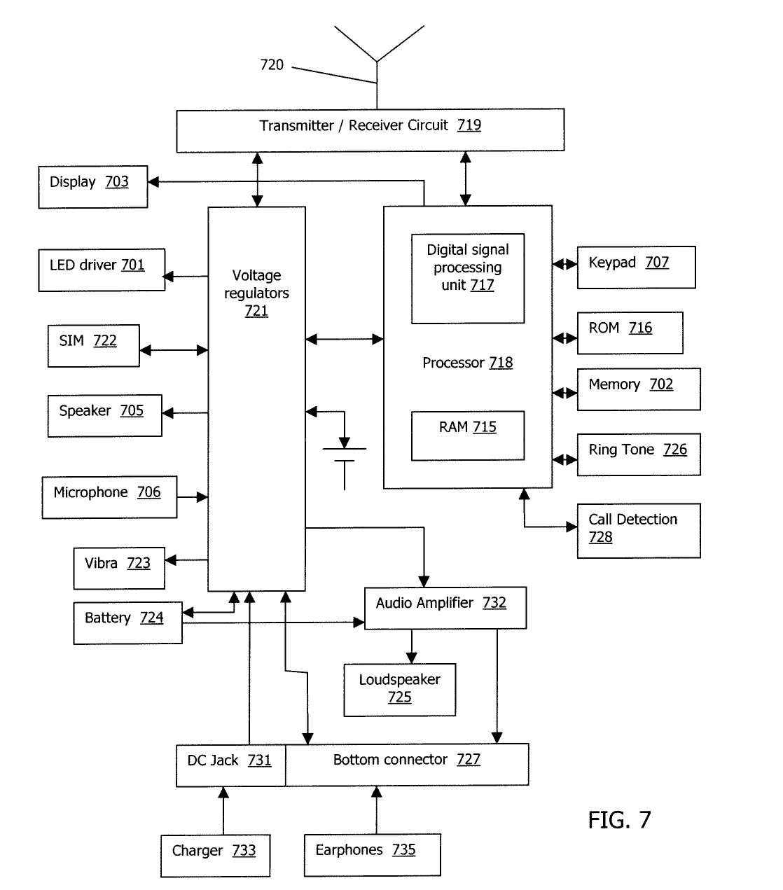

FIG. 7 illustrates in block diagram form one embodiment of a general architecture of the mobile device 500. The mobile communications device 200 may have a processor 718 connected to the display 703 for processing user inputs and displaying information on the display 703. The processor 718 controls the operation of the device and can have an integrated digital signal processor 717 and an integrated RAM 715. The processor 718 controls the communication with a cellular network via a transmitter/receiver circuit 719 and an antenna 720. A microphone 706 is coupled to the processor 718 via voltage regulators 721 that transform the user's speech into analog signals. The analog signals formed are A/D converted in an A/D converter (not shown) before the speech is encoded in the DSP 717 that is included in the processor 718. The encoded speech signal is transferred to the processor 718, which e.g. supports, for example, the GSM terminal software. The digital signal-processing unit 717 speech-decodes the signal, which is transferred from the processor 718 to the speaker 705 via a D/A converter (not shown).

The voltage regulators 721 form the interface for the speaker 705, the microphone 706, the LED drivers 701 (for the LEDS backlighting the keypad 707 and the display 703), the SIM card 722, battery 724, the bottom connector 727, the DC jack 731 (for connecting to the charger 733) and the audio amplifier 732 that drives the (hands-free) loudspeaker 725.

A processor 718 can also include memory 702 for storing any suitable information and/or applications associated with the mobile communications device 500, such as, for example, the borders described above, phone book entries, calendar entries, etc.

The processor 718 also forms the interface for peripheral units of the device, such as for example, a (Flash) ROM memory 716, the graphical display 703, the keypad 707, a ringing tone selection unit 726, and an incoming call detection unit 728. In alternate embodiments, any suitable peripheral units for the device 500 can be included.

The software in the RAM 715 and/or in the flash ROM 716 contains instructions for the processor 718 to perform a plurality of different applications and functions such as, for example, those described herein.

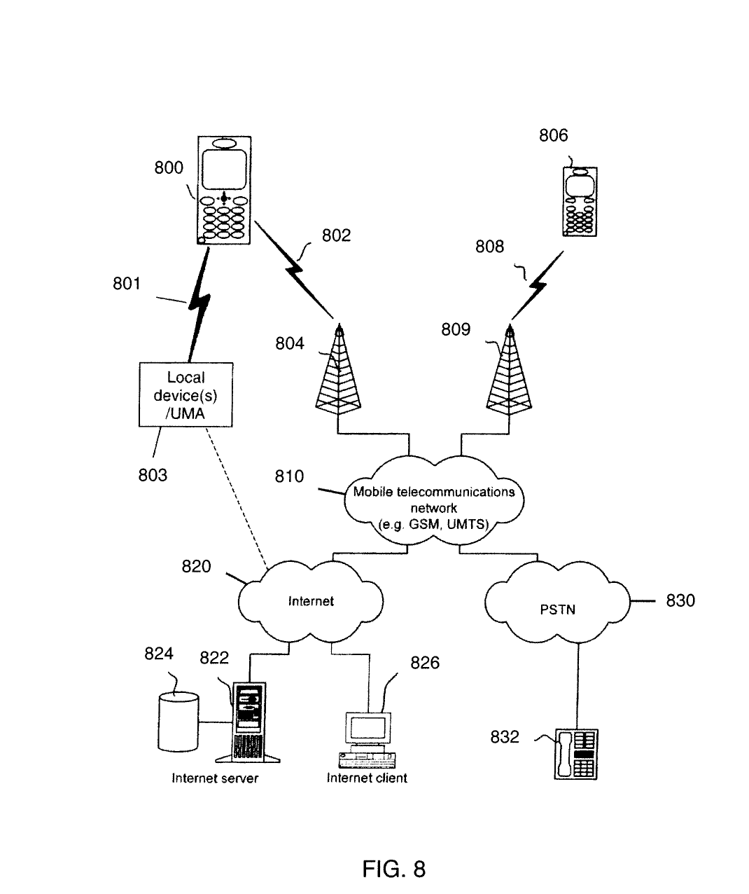

FIG. 8 is a schematic illustration of a cellular telecommunications system, as an example, of an environment in which a communications device 800 incorporating features of an embodiment may be applied. Communication device 800 may be substantially similar to that described above with respect to terminal 500. In the telecommunication system of FIG. 8, various telecommunications services such as cellular voice calls, www/wap browsing, cellular video calls, data calls, facsimile transmissions, music transmissions, still image transmission, video transmissions, electronic message transmissions and electronic commerce may be performed between the mobile terminal 800 and other devices, such as another mobile terminal 806, a stationary telephone 832, or an internet server 822. It is to be noted that for different embodiments of the mobile terminal 800 and in different situations, different ones of the telecommunications services referred to above may or may not be available. The aspects of the invention are not limited to any particular set of services in this respect.

The mobile terminals 800, 806 may be connected to a mobile telecommunications network 810 through radio frequency (RF) links 802, 808 via base stations 804, 809. The mobile telecommunications network 810 may be in compliance with any commercially available mobile telecommunications standard such as GSM, UMTS, D-AMPS, CDMA2000, FOMA and TD-SCDMA.

The mobile telecommunications network 810 may be operatively connected to a wide area network 820, which may be the internet or a part thereof. An internet server 822 has data storage 824 and is connected to the wide area network 820, as is an internet client computer 826. The server 822 may host a www/hap server capable of serving www/hap content to the mobile terminal 800.

For example, a public switched telephone network (PSTN) 830 may be connected to the mobile telecommunications network 810 in a familiar manner. Various telephone terminals, including the stationary telephone 832, may be connected to the PSTN 830.

The mobile terminal 800 is also capable of communicating locally via a local link 801 to one or more local devices 803. The local link 801 may be any suitable type of link with a limited range, such as for example Bluetooth, a Universal Serial Bus (USB) link, a wireless Universal Serial Bus (WUSB) link, an IEEE 802.11 wireless local area network (WLAN) link, an RS-232 serial link, etc. The local devices 803 can, for example, be various sensors that can communicate measurement values to the mobile terminal 800 over the local link 801. The above examples are not intended to be limiting, and any suitable type of link may be utilized. The local devices 803 may be antennas and supporting equipment forming a WLAN implementing Worldwide Interoperability for Microwave Access (WiMAX, IEEE 802.16), WiFi (IEEE 802.11x) or other communication protocols. The WLAN may be connected to the internet. The mobile terminal 800 may thus have multi-radio capability for connecting wirelessly using mobile communications network 810, WLAN or both. Communication with the mobile telecommunications network 810 may also be implemented using WiFi, WiMax, or any other suitable protocols, and such communication may utilize unlicensed portions of the radio spectrum (e.g. unlicensed mobile access (UMA)).

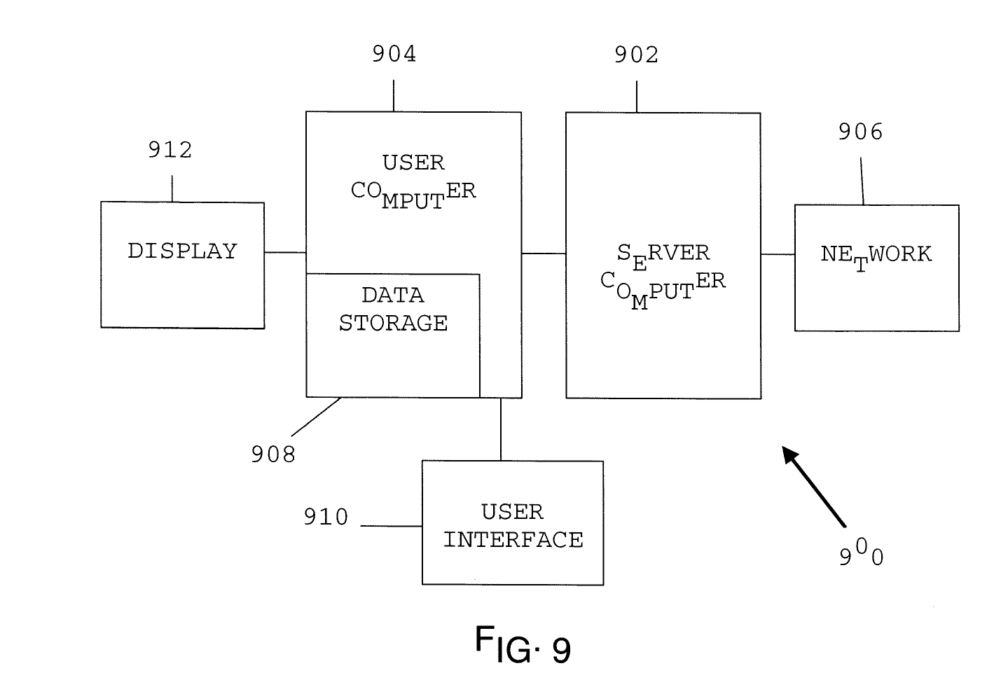

The disclosed embodiments may also include software and computer programs incorporating the process steps and instructions described herein that are executed in different computers. FIG. 9 is a block diagram of one embodiment of a typical apparatus 900 incorporating features that may be used to practice aspects of the embodiments. As shown, a computer system 902 may be linked to another computer system 904, such that the computers 902 and 904 are capable of sending information to each other and receiving information from each other. In one embodiment, computer system 902 could include a server computer adapted to communicate with a network 906. Computer systems 902 and 904 can be linked together in any conventional manner including, for example, a modem, hard wire connection, or fiber optic link. Generally, information can be made available to both computer systems 902 and 904 using a communication protocol typically sent over a communication channel or through a dial-up connection on ISDN line. Computers 902 and 904 are generally adapted to utilize program storage devices embodying machine readable program source code which is adapted to cause the computers 902 and 904 to perform the method steps disclosed herein. The program storage devices incorporating aspects of the invention may be devised, made and used as a component of a machine utilizing optics, magnetic properties and/or electronics to perform the procedures and methods disclosed herein. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 902 and 904 may also include a microprocessor for executing stored programs. Computer 902 may include a data storage device 908 on its program storage device for the storage of information and data. The computer program or software incorporating the processes and method steps incorporating aspects of the invention may be stored in one or more computers 902 and 904 on an otherwise conventional program storage device. In one embodiment, computers 902 and 904 may include a user interface 910, and a display interface 912 from which aspects of the invention can be accessed. The user interface 910 and the display interface 912 can be adapted to allow the input of queries and commands to the system, as well as present the results of the commands and queries.

The embodiments described herein enable a user to intuitively know the where the edges of the document are in relation to the edges of the screen of a device so there is no need for extra user interface elements (e.g. navigation tools and the like) that may obstruct the viewing of the contents of the document. For example, as the user navigates a document, the user may navigate towards a non-visible edge of the document. The non-visible edge is indicated on the screen by a lack of a border along a corresponding edge of the screen. As the non-visible edge of the document approaches the corresponding edge of the screen the intensity of the border may increase. This increasing border intensity tells the user that the edge of the document is approaching the edge of the screen and vice versa. The borders embedded in the document do not obstruct the content of the document. The disclosed embodiments allow a user to personalize applications within the device while at the same time allowing the user to view the contents of a document.

It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

What is claimed is:

1. An apparatus comprising:
a display having a viewable area; and
a processor connected to the display, the processor being configured to present a border along edges of a document so that the border indicates a proximity of a corresponding edge of the document to the viewing area.

2. The apparatus of claim 1, wherein the processor is configured to present the border so that a characteristic of a border fades as the border extends from an edge of the document towards a center of the document.

3. The apparatus of claim 1, wherein the border includes at least one of a two-dimensional image and a three-dimensional image.

4. The apparatus of claim 1, wherein the border includes at least one of smoke, stardust, flames, lightning, hearts, snowflakes, color gradations, lights and animated images.

5. The apparatus of claim 1, wherein a maximized border intensity along an edge of the viewable area corresponds to an edge of the document that is within the viewable area, a faded border intensity along an edge of the viewable area corresponds to non-visible edge of the document that is proximate the viewing area and the absence of the border along an edge of the viewing area corresponds to a non-visible edge of the document that is not proximate to the viewing area.

6. The apparatus of claim 1, wherein the processor is configured to present a different border characteristic along each edge of the document.

7. The apparatus of claim 1, wherein an intensity of the border increases as an edge of the document is moved towards the viewable area and vice versa.

8. The apparatus of claim 1, wherein the apparatus is a mobile communication device.

9. A method comprising:
providing a viewable area;
providing a document within the viewing area where a portion of the document is presented in the viewing area; and
providing a border along the edges of the document to indicate a proximity of the edges of the document to the viewable area.

10. The method of claim 9, wherein the border extends towards a center of the document and a characteristic of a border fades as the border extends from an edge of the document towards the center of the document.

11. The method of claim 9, wherein the border includes a two-dimensional or three-dimensional visualization.

12. The method of claim 9, wherein the boarder includes at least one of smoke, stardust, flames, lightning, hearts, snowflakes, color gradations, lights and animated images.

13. The method of claim 9, wherein a maximized border intensity along an edge of the viewable area corresponds to an edge of the document that is within the viewable area, a faded border intensity along an edge of the viewable area corresponds to non-visible edge of the document that is proximate the viewing area and the absence of the border along an edge of the viewing area corresponds to a non-visible edge of the document that is not proximate to the viewing area.

14. The method of claim 13, further comprising:
resizing the viewable area or the document so the document fits within the viewable area; and
removing the border.

15. The method of claim 9, wherein a different border characteristic is provided along each edge of the document.

16. The method of claim 9, further comprising navigating the document so that as an edge of the document approaches an edge of the viewable area an intensity of a border characteristic increases.

17. A computer program product comprising:
a computer useable medium having computer readable code means embodied therein for causing a computer to indicate a proximity of edges of a document to a viewable area, the computer readable code means in the computer program product comprising:
computer readable program code means for causing a computer to present a border along the edges of a document so that the border indicates a proximity of a corresponding edge of the document to the viewing area.

18. The computer program product of claim 17, the border is presented so that a characteristic of a border fades as the border extends from an edge of the document towards a center of the document.

19. The computer program product of claim 17, wherein a maximized border intensity along an edge of the viewable area corresponds to an edge of the document that is within the viewable area, a faded border intensity along an edge of the viewable area corresponds to non-visible edge of the document that is proximate the viewing area and the absence of the border along an edge of the viewing area corresponds to a non-visible edge of the document that is not proximate to the viewing area.

20. The computer program product of claim 17, further comprising computer readable program code means for causing a computer to navigate the document so that as an edge of the document approaches an edge of the viewable area an intensity of a border characteristic increases.
